(19) United States
(12) Patent Application Publication
(10) Pub. No.: US 2023/0261221 A1
(43) Pub. Date: Aug. 17, 2023

(54) METHOD AND DEVICE FOR THE INITIAL COMMISSIONING OF A FUEL CELL STACK

(71) Applicant: Robert Bosch GmbH, Stuttgart (DE)

(72) Inventors: Christian Diessner, Muehlacker-Muehlhausen (DE); Volker Henrichs, Ludwigsburg (DE)

(21) Appl. No.: 18/003,592

(22) PCT Filed: Jun. 24, 2021
(86) PCT No.: PCT/EP2021/067290

§ 371 Date: Dec. 28, 2022

(30) Foreign Application Priority Data
Jun. 29, 2020 (DE) 10 2020 207 989.7

(51) Int. Cl. H01M 8/04298; H01M 8/247

(52) U.S. Cl. CPC H01M 8/04305; H01M 8/247

(57) ABSTRACT

The invention relates to a method for the commissioning of a fuel cell stack (1), in which the fuel cell stack (1) is commissioned and is supplied with different media during the commissioning and/or operation thereof, the operating state of the fuel cell stack (1) is changed and at least one state variable of the fuel cell stack (1) is acquired. According to the invention, the acquired state variable is calculated in a chemical-physical model of the fuel cell stack (1) or of a fuel cell of the fuel cell stack (1), and at least one model parameter of the model is correspondingly updated. At least one new actuating variable for controlling the media supply and/or the load of the fuel cel stack (1) is subsequently derived from the at least one updated model parameter. The invention further relates to a device for carrying out the method.

### BACKGROUND OF THE INVENTION

The invention relates to a method for the initial commissioning of a fuel cell stack. In addition, the invention relates to a device for carrying out the method according to the invention.

After the assembly of a fuel cell stack, the individual fuel cells of the stack must be activated. This process involves supplying the fuel cells with the particular operating media, generally hydrogen and air, air acting as an oxygen supplier, and supplying with a coolant. Furthermore, the process involves the preparation of the fuel cell stack for operation, for example by humidifying and/or heating. A sequence of different operating states of the fuel cell stack is then run and repeated cyclically until the fuel cell stack has the desired properties. The entire process of the initial commissioning can take several hours. The literature even states a reference cycle of 30 hours.

The long duration of the initial commissioning process has significant disadvantages for industrial mass production. In the production of a large batch, a large number of initial commissioning stations must be provided, which is expensive to purchase. In addition, the many initial commissioning stations require a lot of space or large facility areas. The duration of the process also increases the consumption of operating media, in particular hydrogen, which further increases costs. In addition, the process is generally static, i.e. the same procedure is always carried out and repeated cyclically. It is thus not possible to address the individual, in particular production-specific, properties of a fuel cell stack.

The present invention seeks to remedy this situation. In particular, the duration of the initial commissioning is to be shortened in order to allow economical industrial mass production. Furthermore, the individual properties of a fuel cell stack should be taken into account during initial commissioning.

### SUMMARY OF THE INVENTION

To achieve the object, the method according to the invention and the device according to the invention are proposed. Advantageous developments of the invention can be found in the respective dependent claims.

A method for the initial commissioning of a fuel cell stack is proposed, in which method
the fuel cell stack is put into operation and is supplied with various media during commissioning and/or operation,
the operating state of the fuel cell stack is changed, and
at least one state variable of the fuel cell stack is captured.

According to the invention, the captured state variable is calculated using a chemical-physical model of the fuel cell stack or of a fuel cell of the fuel cell stack, and at least one model parameter of the model is correspondingly updated. At least one new actuating variable for controlling the media supply and/or the load on the fuel cell stack is then derived from the at least one updated model parameter.

The proposed method is based on the principle that basic processes in a fuel cell or in a fuel cell stack can be described by a chemical-physical model. By using such a model to calculate the at least one state variable determined during the commissioning or operation of the fuel cell stack, the model parameters can be updated or adapted continuously so that a control loop is established for the commissioning. The commissioning therefore does not follow any fixed sequence but takes place in a dynamic process which depends on the individual properties of the fuel cell stack. This has the advantage that each fuel cell stack can be handled individually.

Ideally, not only is one state variable captured but different state variables are captured during the commissioning or operation of the fuel cell stack and calculated using the model. The at least one or the different state variables can relate, for example, to the temperature, the gas flows, the fuel consumption, the cell voltage and/or the current load of the fuel cell stack.

A sensor is preferably used to capture the at least one state variable. Further preferably, the sensor forwards a corresponding measurement signal to a model-based controller, with the aid of which the captured state variable is calculated using a chemical-physical model of the fuel cell stack or of a fuel cell of the fuel cell stack, and at least one model parameter of the model is correspondingly updated. At least one new actuating variable for controlling the media supply and/or the load on the fuel cell stack can then be derived therefrom with the aid of the controller.

The proposed method corresponds to a learning process, since the model and/or controller parameters are continuously updated or adapted. In this way, the duration of the commissioning process can be significantly reduced. The same applies to fuel consumption. Commissioning a fuel cell stack in less time simultaneously allows a better utilization of plant technology so that economical mass production is possible.

Preferably, a plurality of actuating variables for controlling the media supply are derived from the at least one updated model parameter. In this way, each medium required by the fuel cell stack can be controlled separately with the aid of the actuating variables.

Advantageously, the load on the fuel cell stack is also controlled separately. The operating state of the fuel cell stack can thus be changed in a targeted manner and the commissioning of the fuel cell stack can be completed more quickly.

In a development of the invention, it is proposed that the at least one updated model parameter is transmitted to a database, a cloud and/or a neural network. The data obtained during commissioning can thus be subjected to an evaluation and/or made available to similar processes. Furthermore, the production of fuel cell stacks can be optimized with the aid of the data obtained. The properties of the various models of fuel cell stacks and/or fuel cells can thus be continuously improved. Furthermore, it is possible to make changes in production visible and/or to reveal deviations in the components used. In particular when using a neural network, it is possible in this way to realize a continuously self-optimizing production in the sense of Industry 4.0.

Furthermore, it is proposed that, when updating the at least one model parameter, at least one empirical value is taken into account, which is taken from a database, a cloud and/or a neural network. This means that during the updating or adaptation of the model and/or controller parameters, such data can also be taken into account as were obtained during previous commissioning processes. In this way, the method can be further optimized.

At the completion of initial commissioning, the fuel cell stack is preferably characterized and/or classified on the basis of at least one characteristic value. Characterization or classification is intended to differentiate the fuel cell stack. Classification can be carried out, for example, according the maximum performance and/or expected service life of the fuel cell stack.

Further preferably, the at least one characteristic value of the fuel cell stack, preferably in combination with at least one actuating or control variable, is stored in a memory module. The memory module acts as an electronic rating plate and can be supplied with the fuel cell stack.

The additionally proposed device for carrying out a method according to the invention comprises a controller having a computer and a data memory in which a chemical-physical model of a fuel cell stack or of a fuel cell of the fuel cell stack is stored. With the aid of the controller, at least one captured state variable of the fuel cell stack can thus be calculated using the stored model. Furthermore, with the aid of the controller from at least one updated model parameter, at least one new actuating variable can be derived for controlling the media supply and/or the load on the fuel cell stack.

For this purpose, the controller is preferably connected for data transmission to a sensor system of the fuel cell stack and also to at least one actuator, by means of which the media supply and/or the load on the fuel cell stack can be influenced. The actuator can be any component in a supply path of a medium, by means of which the mass flow of the particular medium can be changed.

It is further proposed that the controller be connected or be connectable for data transmission to a database, a cloud and/or a neural network. The controller can thus transmit all the data obtained, in particular updated model and/or controller parameters, to the database, the cloud and/or the neural network. Furthermore, it can retrieve empirical values from the database, the cloud and/or the neural network, which can be taken into account during the continuous updating or adaptation of the model.

The controller can further be connected to a display device and/or to a central computer. In this case, the initial commissioning process can be monitored from a central control center. In addition, the central control center can intervene in the initial commissioning process. Via the central control center, a plurality of commissioning processes can also be monitored simultaneously, which is advantageous for the mass production of fuel cell stacks.

### BRIEF DESCRIPTION OF THE DRAWINGS

The invention is explained in more detail below with reference to the accompanying drawings. In the drawings:

FIG. 1 is a schematic representation of an initial commissioning of a fuel cell stack according to the method according to the invention, and

FIG. 2 is a schematic representation of an initial commissioning of a fuel cell stack according to the prior art.

### DETAILED DESCRIPTION

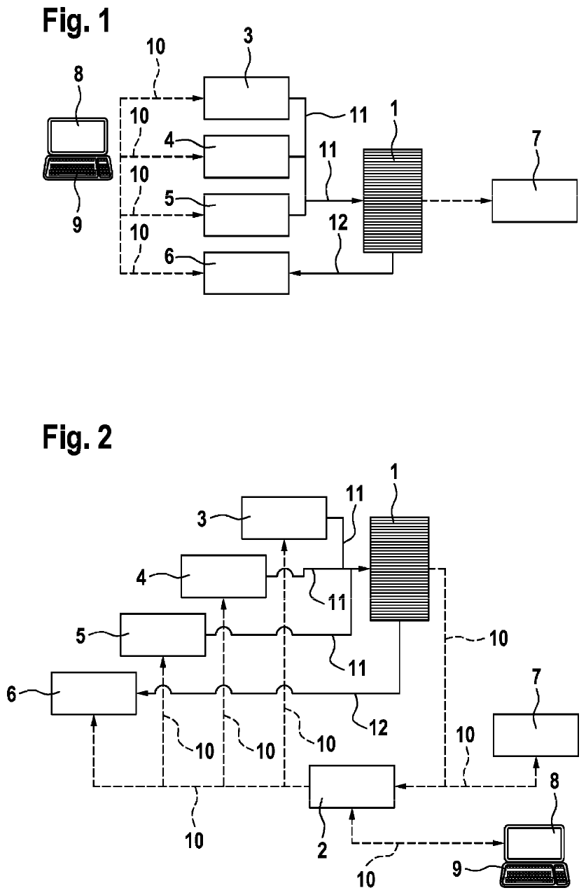

FIG. 1 shows a fuel cell stack 1 during the initial commissioning, during which the fuel cell stack 1 is supplied with different media via three supply paths 11. Via the upper supply path 11, the fuel cell stack 1 is supplied with a fuel, in the present case hydrogen (H₂). The middle supply path 11 is used for the supply of oxygen (O₂) in the form of air. A coolant is supplied to the fuel cell stack 1 via the supply path 11 situated therebelow. In all three supply paths 11, one actuator 3, 4, 5 is arranged in each case, by means of which the mass flow of the particular medium can be influenced. In the fuel cell stack 1, the media hydrogen and oxygen are converted into electrical energy or power. This leaves the fuel cell stack 1 via a power line 12. A further actuator 6 is arranged in the power line 12.

A controller 2 is provided for controlling the media supply and/or the load on the fuel cell stack 1. This is connected via data lines 10 to the actuators 3, 4, 5, 6. A further data line 10 connects the regulator 2 to the fuel cell stack 1 or to a sensor system (not shown) of the fuel cell stack 1. The controller 2 thus receives data relating to certain state variables of the fuel cell stack 1. The controller 2 calculates these data using a chemical-physical model of the fuel cell stack 1, which is stored in a data memory (not shown) of the controller 2. For this purpose, the controller 2 has a computer (not shown) in addition to the data memory. From the correspondingly updated model, the computer calculates at least one new actuating variable for at least one actuator 3, 4, 5, 6.

With the aid of the model-based controller 2, a control loop is accordingly established which significantly shortens the initial commissioning process, since the process is dynamic and takes into account the individual properties of the fuel cell stack 1. Furthermore, the controller 2 can provide the data obtained to a database 7, cloud and/or a neural network, so that empirical values can be collected and evaluated. These help to continuously optimize the production of fuel cell stacks.

The sequence of the method can be monitored, for example, from a central control center. In the present case, the control center has a display device 8 and a computer 9.

To illustrate the advantages of the method according to the invention shown in FIG. 1, a method according to the prior art is described below with reference to FIG. 2. Identical parts have been given the same reference signs.

In contrast to the method according to the invention, the initial commissioning of a fuel cell stack 1 according to the sequence shown in FIG. 2 proceeds according to a fixed schedule. This means that the actuators 3, 4, 5 for controlling the media supply and/or the actuator 6 for controlling the load on the fuel cell stack 1 are actuated following a program which is controlled by a control center (display device 8 and computer 9). This program is repeated until the desired characteristic values are reached. However, this process can take up to 30 hours or more. This is because it is not possible to deal with the fuel cell stack individually.

1. A method for the initial commissioning of a fuel cell stack (1), the method comprising
putting the fuel cell stack (1) into operation;
supplying the fuel cell stack with various media,
changing the operating state of the fuel cell stack (1), and
determining at least one state variable of the fuel cell stack (1),
wherein the determined state variable is calculated in a chemical-physical model of the fuel cell stack (1) or of a fuel cell of the fuel cell stack (1) and at least one model parameter of the model is correspondingly updated, and at least one new actuating variable is then derived from the at least one updated model parameter for controlling fa) the media supply, (b) the load on the fuel cell stack (1), or both (a) and (b).

2. The method according to claim 1,
wherein a plurality of actuating variables for controlling the media supply are derived from the at least one updated model parameter and each medium is controlled separately with the aid of the actuating variables.

3. The method according to claim 1,
wherein the load on the fuel cell stack (1) is controlled separately.

4. The method according to claim 1,
wherein the at least one updated model parameter is transmitted to a database, a cloud, and/or a neural network.

5. The method according to claim 1,
wherein, when updating the at least one model parameter, at least one empirical value is taken into account that is taken from a database, a cloud and/or a neural network.

6. The method according to claim 1,
wherein at the completion of initial commissioning, the fuel cell stack (1) is characterized and/or classified on the basis of at least one characteristic value.

6. The method according to claim 6,
wherein the at least one characteristic value of the fuel cell stack (1), is stored in a memory module.

8. A device comprising:
a controller (2) having a computer and a data memory in which a chemical-physical model of a fuel cell stack (1) or of a fuel cell of the fuel cell stack (1) is stored, wherein the controller (2) is connected for data transmission to a sensor system of the fuel cell stack (1) and to at least one actuator (3, 4, 5, 6) by means of which the media supply and/or the load of the fuel cell stack (1) can be influenced and wherein the controller (2) is configured to
put the fuel cell stack (1) into operation;
control supplying the fuel cell stack with various media,
change the operating state of the fuel cell stack (1), and
determine at least one state variable of the fuel cell stack (1),
wherein the determined state variable is calculated in a chemical-physical model of the fuel cell stack (1) or of a fuel cell of the fuel cell stack (1) and at least one model parameter of the model is correspondingly updated, and at least one new actuating variable is then derived from the at least one updated model parameter for controlling (a) the media supply, (b) the load on the fuel cell stack (1), or both (a) and (b).

9. The device according to claim 8,
wherein the controller (2) is connected or connectable for data transmission to a database (7), a cloud and/or a neural network.

10. The device according to claim 8,
wherein the controller (2) is connected to a display device (8) and/or to a central computer (9).
